(19) United States
(12) Patent Application Publication
(10) Pub. No.: US 2024/0351183 A1
(43) Pub. Date: Oct. 24, 2024

(54) Storage System

(71) Applicant: Kevin Boenisch, Worcester, MA (US)

(72) Inventor: Kevin Boenisch, Worcester, MA (US)

(21) Appl. No.: 18/641,877

(22) Filed: Apr. 22, 2024

Related U.S. Application Data
(60) Provisional application No. 63/461,008, filed on Apr. 21, 2023.

(51) Int. Cl. B25H 3/02; B65D 21/02; B65D 25/08; G01B 3/56

(52) U.S. Cl. CPC B25H 3/02; B65D 21/0224; B65D 25/08; G01B 3/563

(57) ABSTRACT

A storage system where multiple containers having a plurality of vertical slots on all four internal sides for receiving dividers; one or more dividers that can be installed in various positions in the container, in either direction, and lock into place. Each divider has flexible tabs at either end, and each slot where a divider can be installed in the container includes an opening for this tab to lock into. A latch mechanism can be easily installed or removed on the container for locking multiple containers on top of each other when stacked. The latch mechanism can be installed on two opposing sides at the bottom of the container and locks into an edge on the top of another container. A lid that locks on top of the container and includes measuring features for components that may be stored in the container.

### FEDERALLY SPONSORED RESEARCH

Not Applicable

### SEQUENCE LISTING OR PROGRAM

Not Applicable

### TECHNICAL FIELD OF THE INVENTION

The present invention relates to storage systems. More particularly, the invention relates to a storage system having internal locking dividers which is stackable and nests together using a specific latch mechanism for joining two containers of the storage system.

### BACKGROUND OF THE INVENTION

Storage containers and systems having a plurality of molded plastic drawers or containers therein have been utilized for a number of years for storing small parts.

Typically, drawers are provided with vertically extending aligned grooves or other seating means in the opposed side walls which removably seat compartment dividers so as to form a multiplicity of storage areas which permit a variety of sizes or styles of small parts to be stored and categorized.

It is an object of the present invention to provide a novel storage system having a multiplicity of compartment dividers for storing small parts and the like which lock into place.

Typically, stacking or nesting storage containers are designed with specific channels and protrusions that engage for secure stacking, alignment, and retention. Many such storage containers and systems use complex handle and latching mechanisms that are costly to manufacture, are susceptible to breakage, and do not include means to secure one container to another.

It is an object of the present invention to provide a novel storage system having latching assemblies which retain/lock/secure containers together, each assembly having a handle with springs that can engage or disengage another container and two multi-prong clips acting as a pivot for the handle. The latching assembly can be installed and removed in the storage container easily by means of inserting or removing the multi-prong clips, reducing the manufacturing complexity and creating a user-configurable means for direct connection between containers in the storage system.

### SUMMARY OF THE INVENTION

The device of the present invention is a storage system where multiple containers are nested together. The storage system consists of the following components: a storage container having a plurality of vertical slots on all four internal sides for receiving dividers; one or more dividers that can be installed in various positions in the container, in either direction, and lock into place; a latch mechanism that can be installed on the container for locking multiple containers on top of each other when stacked; and a lid that locks on top of the container and includes measuring features for components that may be stored in the container. In a preferred embodiment, all components are made of injection molded plastic.

Grid dividers are designed to lock into place when installed in the container to prevent the dividers from moving or parts from being able to “migrate” underneath loose dividers. Each divider has flexible tabs at either end, and each slot where a divider can be installed in the container includes an opening for this tab to lock into and engage the underside of the rim. The grid divider taught by the present invention engages the vertical side channels of the container.

A latch mechanism can be installed on two opposing sides at the bottom of the container and locks into an edge of the rim on the top of another container when stacked. The latch mechanism can be inserted or removed from openings on the container and clips into place, using a standard three prong clip. The latch mechanism includes the latch itself, two elements that clip into the container and serve as pivots for the latch, and two torsion springs.

A lid that locks onto the storage container and includes elements for measuring/sorting components (robotics parts) that may be stored inside the container. The lid is further defined by a recess for aligning machine screws with measurement markings; protrusions for aligning components such as drive shafts with measurement markings; protrusions at ½″ spacing matching holes on structural components, to allow for measuring these components by the number of holes; and a protractor for use by professionals or amateurs in their projects.

Rails can alternatively be used to hold individual containers. Recesses on the lower face of the rim of the container can engage protrusions on the upper face of the rails so that the container can “index” in the appropriate inserted or extended positions. Rails can be used in an opposing pair to suspend the container and allow the container to be slid in and out, similar to a drawer.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a perspective CAD view of the storage system of the present invention where multiple containers are nested together.

FIG. 2 illustrates the grid divider taught by the present invention.

FIG. 3 illustrates how the grid divider taught by the present invention engages the vertical side channels of the container.

FIG. 4 is a cut away view illustrating how the grid divider taught by the present invention engages the vertical side channels of the container.

FIGS. 5-6 illustrate the latch mechanism taught by the present invention.

FIG. 7 illustrates how the latch mechanism taught by the present invention engages the external side channels of the container.

FIG. 8 illustrates the top/lid used for the containers of the storage system taught by the present invention.

FIG. 9 is a perspective view of the storage system of the present invention where multiple containers are nested together.

FIG. 10 illustrates rails which can be alternatively attached to the containers, even when nested together.

FIG. 11 illustrates how the rails can be used in an opposing pair to suspend the container, placed so that the container can “index” in the appropriate inserted or extended positions.

FIG. 12 is a planar front view of the grid divider of the storage system of the present invention.

FIG. 13 is a perspective view of the grid divider of the storage system of the present invention.

FIG. 14 is a planar side view of the grid divider of the storage system of the present invention.

FIG. 15 is a planar top view of the grid divider of the storage system of the present invention.

FIG. 16 is a planar bottom view of the grid divider of the storage system of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

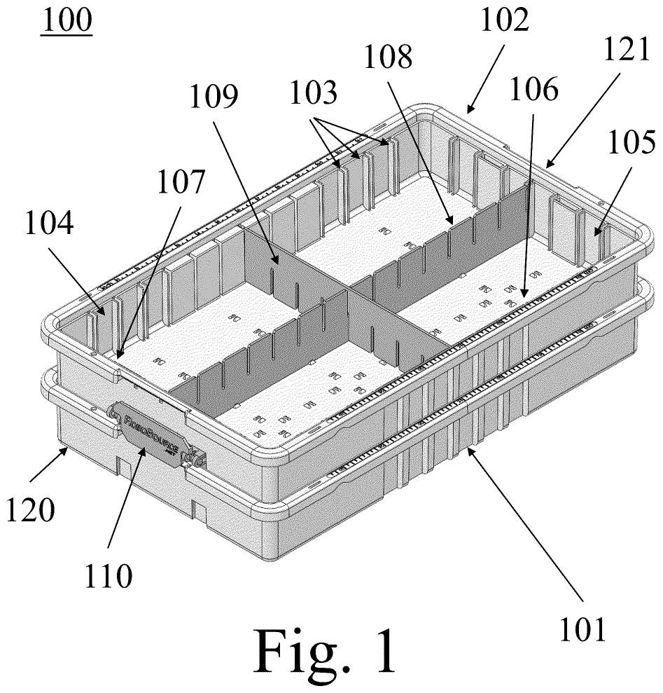

The device of the present invention is a storage system. FIG. 1 is a perspective CAD view of the storage system 100 of the present invention where multiple storage containers 101 and 102 are nested together.

The storage system 100 consists of the following components: a storage container 101 and 102 having a plurality of vertical slots 103 on all four internal sides 104, 105, 106, and 107 for receiving dividers 108 and 109; one or more dividers 108 and 109 that can be installed in various positions in the storage container 101 and 102, in either direction, and lock into place; a latch mechanism 110 that can be installed on the container 101 and 102 for locking multiple containers 101 and 102 on top of each other when stacked; and a lid 111 that locks on top of the storage container 101 and 102 and includes measuring features 112 for components that may be stored in the storage container 101 and 102. In a preferred embodiment, all components are made of injection molded plastic.

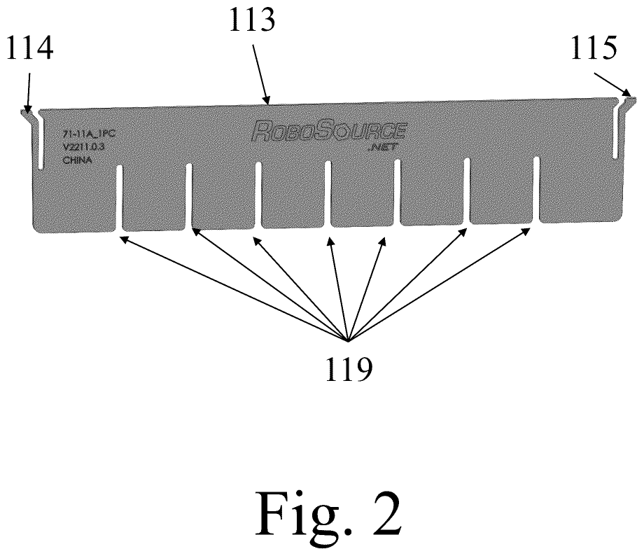

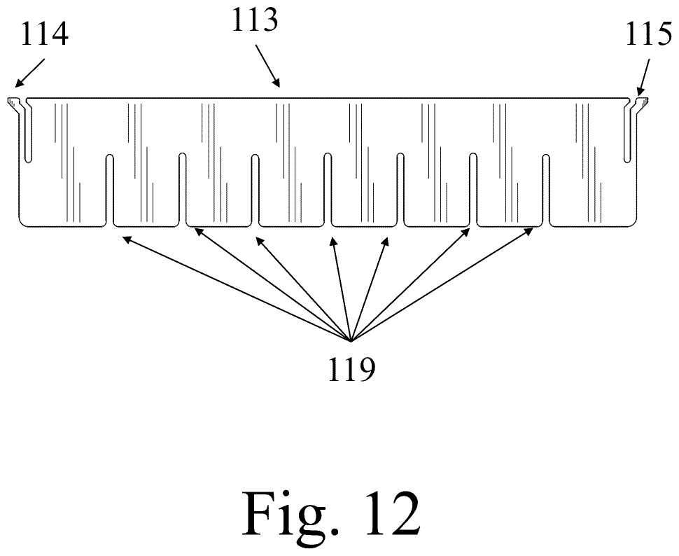

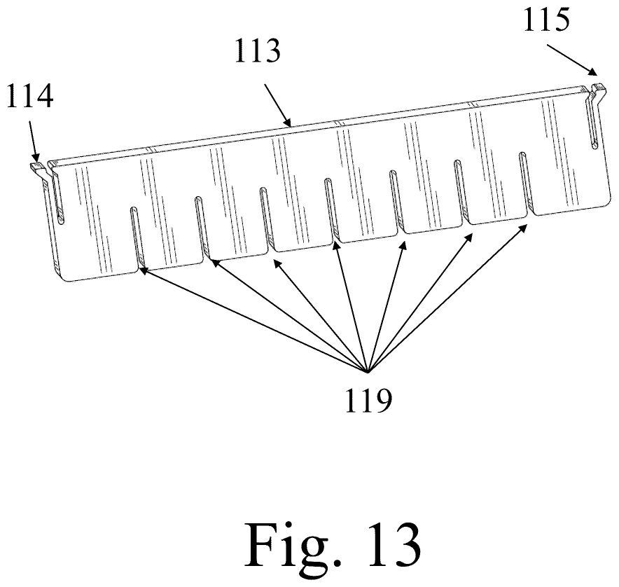

FIGS. 2, 12, and 13 illustrate the grid divider system comprised of one or more grid dividers 113 taught by the present invention. Grid dividers 113 are designed to lock into place when installed and prevent them from moving or parts from being able to “migrate” underneath loose dividers 113.

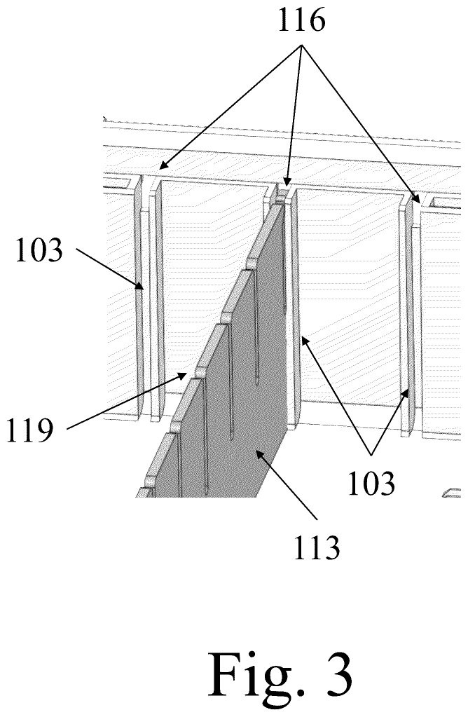

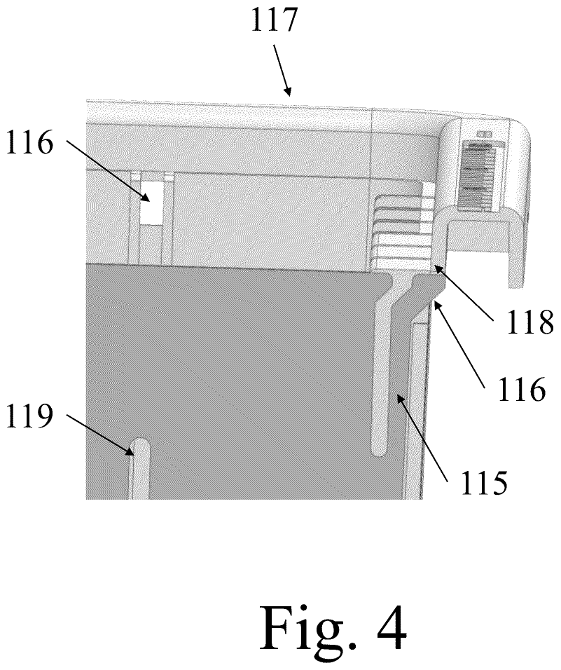

As shown in FIGS. 2, 12, and 13, each divider 113 has flexible tabs 114 and 115 at either end, and each slot where a divider can be installed in the container 101 and 102 includes an opening 116 for this the flexible tabs 114 and 115 to lock into as shown in FIGS. 3 and 4. FIG. 3 illustrates how the grid divider 113 taught by the present invention engages the vertical side channels 103 of the container 102. FIG. 4 is a cut away view illustrating how the grid divider 113 taught by the present invention engages the vertical side channels 103, opening in the side 116, and underside of the rim 118 of the container 102. Each grid divider 113 has flexible tabs 114 and 115 at either end, and each slot 119 where a divider 113 can be installed in the container 102 includes an opening 116 for this the flexible tabs 114 and 115 to lock into and engage the underside of the rim 118.

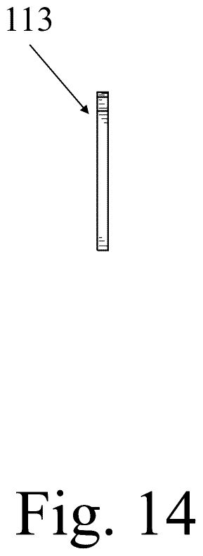

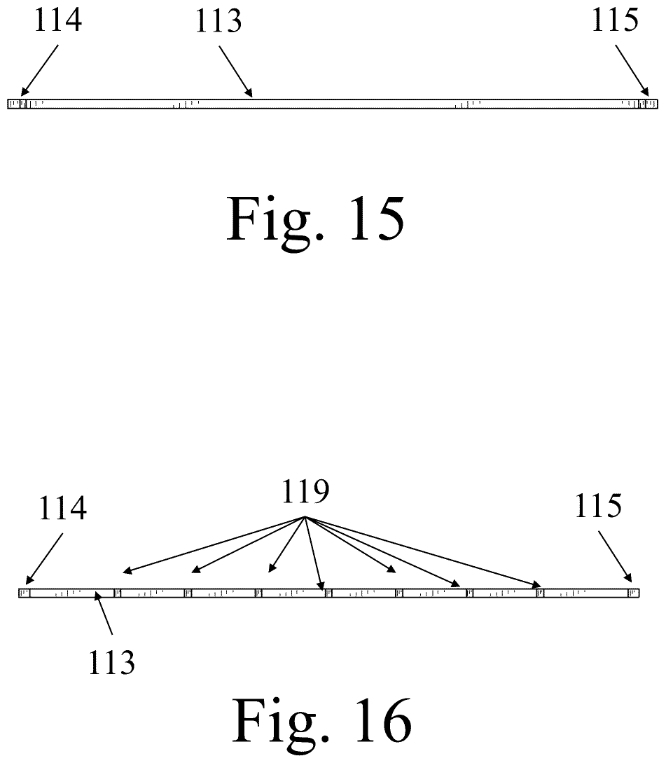

FIG. 14 is a planar side view of the grid divider 113 of the storage system 100 of the present invention. FIG. 15 is a planar top view of the grid divider 113 of the storage system 100 of the present invention. FIG. 16 is a planar bottom view of the grid divider 113 of the storage system 100 of the present invention.

As discussed, generic divider systems are known, but the prior art does not teach or suggest dividers that lock into place generally or as specifically taught by the present invention using a tab 114 and 115 to lock into the opening 116 located on the underside of the rim 118.

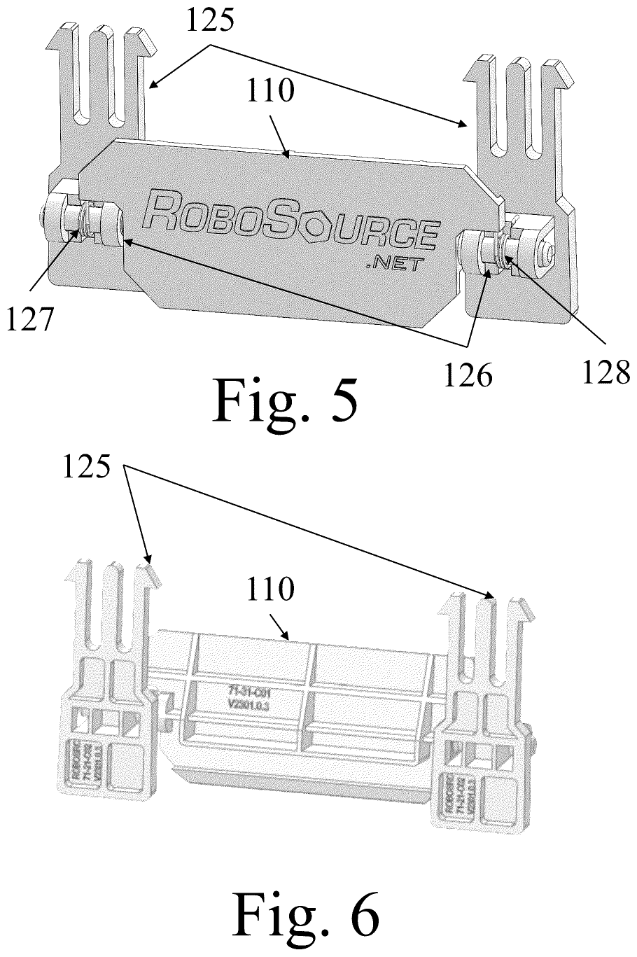

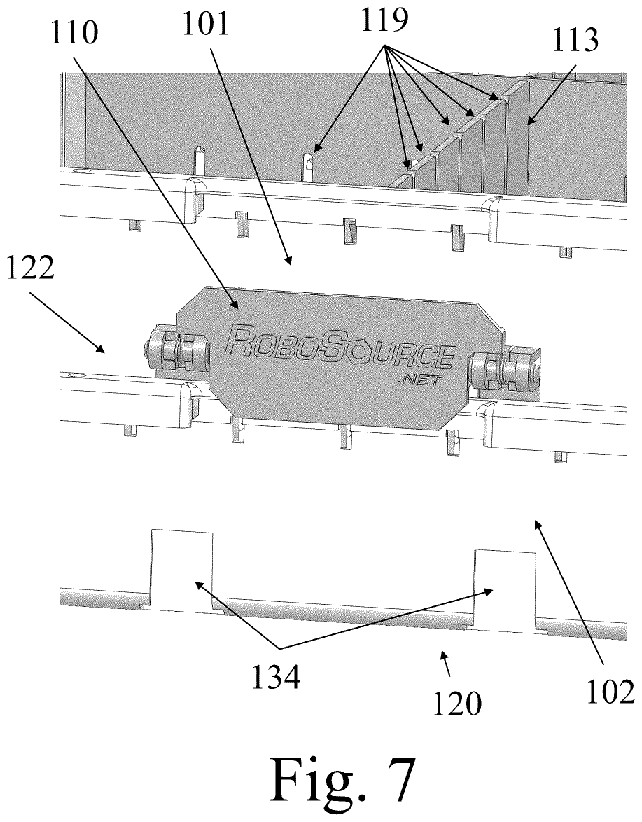

FIGS. 5-7 illustrate a latch mechanism 110 using a specific latch mechanism 110 for joining two containers 101 and 102 of the storage system 100, which can be installed on two opposing sides 120 and 121 at the bottom 122 of the container 101 and locks into an edge on the rim 118 on the top 117 of another container 102 is shown in FIG. 7. The latch mechanism 110 can be inserted or removed from openings 134 on the container and clips into place, using a standard three prong clip 125. As shown in FIGS. 5-6, the latch mechanism 110 includes the latch itself, two three prong clip 125 elements that clip into the container 101 and 102 and serve as pivots 126 for the latch 110, and two torsion springs 127 and 128. The latching configuration and latch mechanism 110 taught by the present invention can be easily installed/removed on the container 101 and 102 and is unique and non-obvious in view of the prior art and current prior art devices.

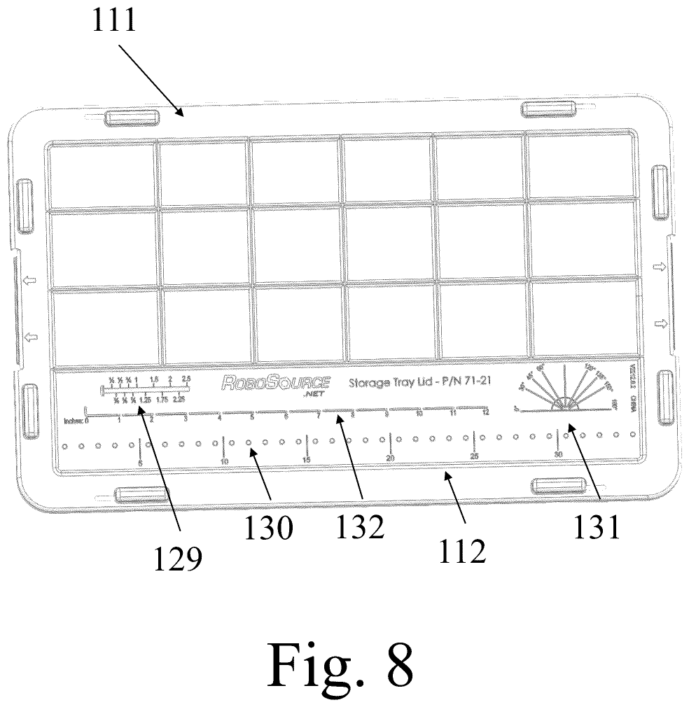

FIG. 8 illustrates the top/lid 111 used for the containers 101 and 102 of the storage system 100 taught by the present invention. The present invention teaches a lid 111 that locks onto the storage container 101 and 102 and includes elements for measuring/sorting 112 components (robotics parts) that may be stored inside the container 101 and 102. The lid 111 is further defined by a recess 129 for aligning machine screws with measurement markings 112; protrusions 132 for aligning components such as drive shafts with measurement markings 112; protrusions 130 at ½″ spacing matching holes on structural components, to allow for measuring these components by the number of holes; and a protractor 131 for use by professionals or amateurs in their projects.

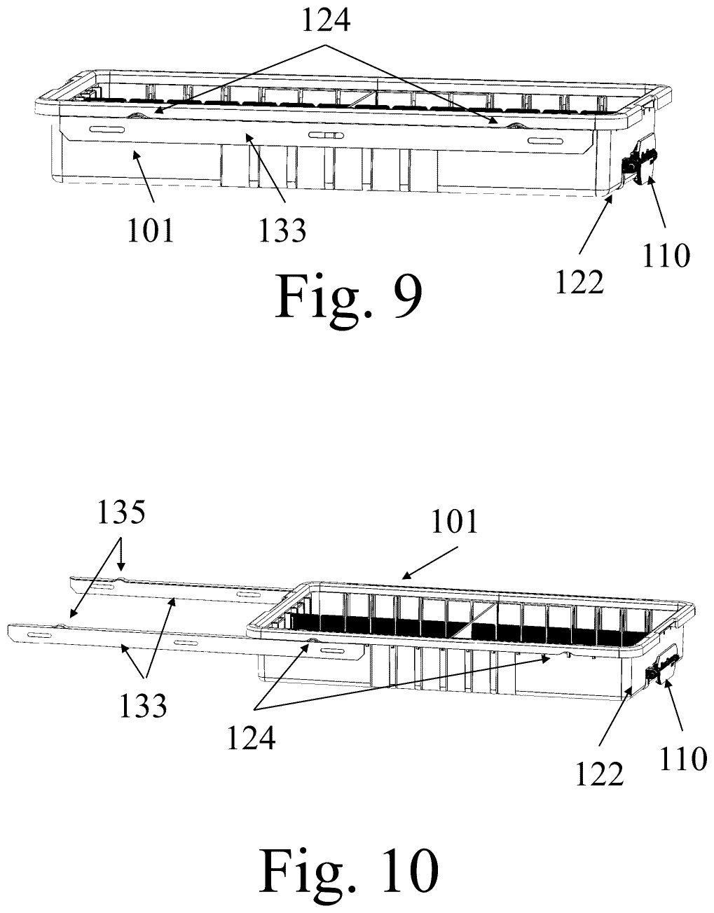

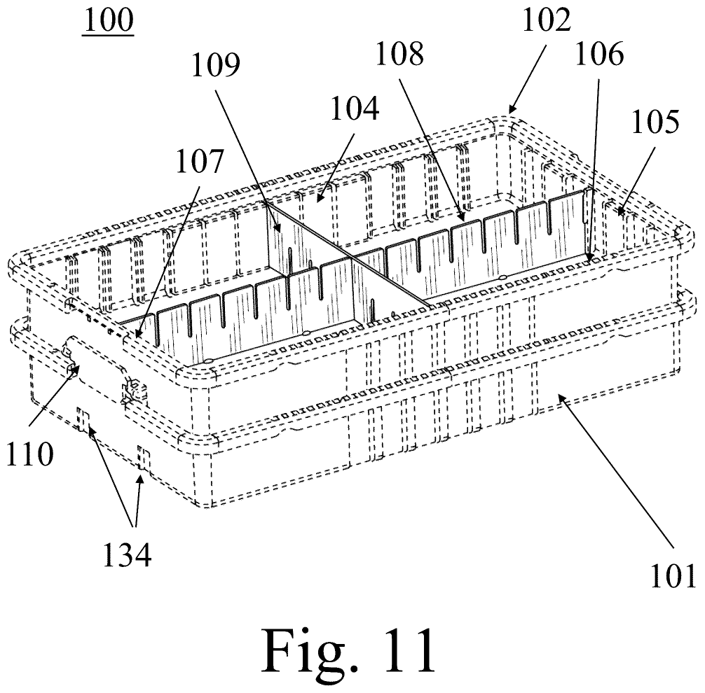

FIGS. 9-10 illustrate rails 133 which can alternatively be used to hold individual containers 101 and 102. Recesses 124 on the lower face of the rim 118 of the container 101 and 102 can engage protrusions 135 on the upper face of the rails 133. Rails 133 can be used in an opposing pair to suspend the container 101 and 102 and allow the container 101 and 102 to be slid in and out, similar to a drawer, and the protrusions 135 and recesses 124 allow the container 101 and 102 to “index” in the appropriate inserted or extended positions as shown in FIGS. 9-10.

In one exemplary embodiment, a pair of opposing rails 133 would be mounted in a cabinet and used to suspend a single container.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A storage system, comprising
a container; wherein
the interior of the container is further comprised of
a plurality of vertical slots on all four internal sides for receiving dividers; and
one or more dividers are installed in various positions in the container, in either direction and lock into place.

2. The storage system of claim 1, wherein
grid dividers are designed to lock into place when installed and prevent them from moving or parts from being able to migrate underneath loose dividers.

3. The storage system of claim 2, wherein
each divider has flexible tabs at either end; and
each vertical slot on the interior of the container where a divider can be installed in the container includes an opening for this tab to lock into.

4. The storage system of claim 1, wherein
all components are made of Polypropylene (PP) plastic.

5. The storage system of claim 1, further comprising
a lid that locks on top of the container and includes measuring features for components stored in the container.

6. The storage system of claim 5, wherein
the top/lid locks onto the storage container and includes elements for measuring/sorting components that may be stored inside the container.

7. The storage system of claim 6, wherein
the lid is further defined by
a recess for aligning machine screws with measurement markings;
protrusions for aligning components with measurement markings;
protrusions at ½″ spacing matching holes on structural components, to allow for measuring these components by the number of holes; and
a protractor.

8. The storage system of claim 5, wherein
all components are made of Polypropylene (PP) plastic.

9. The storage system of claim 1, further comprising
a latch mechanism that can be installed on the exterior of the container for locking multiple containers on top of each other when stacked.

10. The storage system of claim 9, wherein
the latch mechanism is installed on two opposing exterior sides at the bottom of a first container; and
the latch mechanism locks into an edge on the top of a second container.

11. The storage system of claim 10, wherein
the latch mechanism is inserted or removed from openings on the container and clips into place, using two standard three prong clips.

12. The storage system of claim 9, wherein
the latch mechanism is further comprised of
the latch itself,
two elements that clip into the container and serve as pivots for the latch, and
two torsion springs.

13. The storage system of claim 9, wherein
all components are made of Polypropylene (PP) plastic.

14. The storage system of claim 1, further comprising
rails providing the container interface with/support the bottom side of the rim providing suspension.

15. The storage system of claim 14, wherein
recesses and protrusions on the lower face of the rim of the container index a first container to a second container.

16. The storage system of claim 15, wherein
recesses on the lower face of the rim of the container and the matching protrusions on rails are used in an opposing pair so that the container can “index” in an inserted or extended position.

17. The storage system of claim 16, wherein
a pair of opposing rails are mounted in a cabinet and used to suspend a single container.

18. The storage system of claim 9, further comprising
a lid that locks on top of the container and includes measuring features for components stored in the container.

19. The storage system of claim 18, wherein
the top/lid locks onto the storage container and includes elements for measuring/sorting components that may be stored inside the container.

20. The storage system of claim 19, wherein
the lid is further defined by
a recess for aligning machine screws with measurement markings;
protrusions for aligning components with measurement markings;
protrusions at ½″ spacing matching holes on structural components, to allow for measuring these components by the number of holes; and
a protractor.
